(19) United States
(12) Patent Application Publication
(10) Pub. No.: US 2004/0057229 A1
(43) Pub. Date: Mar. 25, 2004

(54) Illuminated eye protection device

(76) Inventor: Scott Thomas, Haverhill, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/624,089

(22) Filed: Jul. 21, 2003

Related U.S. Application Data
(60) Provisional application No. 60/397,867, filed on Jul. 22, 2002.
(60) Provisional application No. 60/403,118, filed on Aug. 13, 2002.

(51) Int. Cl. F21V 21/08

(52) U.S. Cl. 362/103

(57) ABSTRACT

An illuminated eye protection device includes a frame, a lens member attached to the frame, and at least three lights integrated with the frame above the lens. The frame has a first corner and a second corner. In an embodiment, a first light can be rotatably mounted to the first corner of the frame, a second light can be rotatably mounted to the second corner of the frame, and a third light can be mounted to the center of the frame above the lens.

### RELATED APPLICATIONS

This application claims the benefit of U.S. Provisional Application No. 60/397,867, filed on Jul. 22, 2002, and U.S. Provisional Application No. 60/403,118, filed on Aug. 13, 2002, the entire teachings of which are incorporated herein by reference.

### BACKGROUND

Eye protection devices, such as safety glasses, have been used to protect a wearer's eyes from objects that may damage the eyes. For example, carpenters wear safety glasses to protect their eyes from objects that may become airborne while performing their daily work activities. Often, even with eye protection, the wearer is subject to other dangers caused by insufficient illumination. For instance, a carpenter may injure a hand while hammering because of an insufficient illumination condition. To address these conditions, the wearer typically uses an auxiliary light source to help illuminate a given work area. For example, an automobile mechanic typically hangs a light under the hood of an automobile to help illuminate the automobile's engine compartment. However, these auxiliary light sources cast shadows in the work area that can hide dangers such as spraying fluids, moving parts, or flying objects.

### SUMMARY

There is a need for an improved eye protection device, such as safety glasses or eye shields, that provides eye safety to a wearer while illuminating potential dangers before the occurrence of bodily harm or death. Further, the eye protection device should assist the wearer in the performance of a specific task.

Accordingly, an illuminated eye protection device includes a frame, a lens member attached to the frame, and at least three lights integrated with the frame above the lens. The frame has a first corner and a second corner. In an embodiment, a first light can be rotatably mounted to the first corner of the frame, a second light can be rotatably mounted to the second corner of the frame, and a third light can be mounted to the center of the frame above the lens.

In an embodiment, the eye protection device can include at least one power source integrated with the frame and electrically connected to the three lights. The power source can be a battery or a solar cell. A first power source can be located aside the center light and a second power source can be located opposite the first power source and aside the center light. A switch can be integrated with the frame and electrically connected to the three lights and the power source. The switch can be a rocker-type switch.

In an embodiment, a protruding member can be attached to each of the first and second lights to control the rotation of each of the first and second lights. The three lights can point slightly downward. The lights can be light emitting diodes (LEDs) or white light LEDs. The lens and the frame can be made from a polycarbonate material. The illuminated eye protection device can be illuminated safety glasses or an illuminated safety shield.

In an embodiment, the frame includes a pair of temples and a bridge member connecting the temples, the bridge member being positioned downward from the temples to provide a beam of light which intersects a wearer's line of sight.

A method for protecting the human eye includes wearing an eye protection device having lights, activating the lights, and directing the lights to form a beam of light on a work area.

The present invention provides many advantages. For example, the present invention provides eye protection for a wearer while assisting the wearer in performing specified tasks due to insufficient illumination.

### BRIEF DESCRIPTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

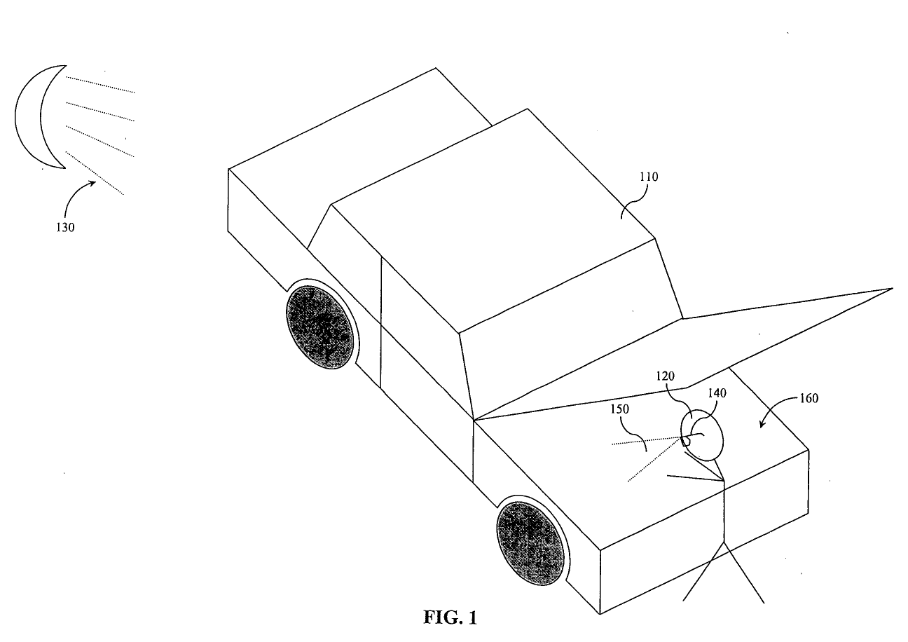

FIG. 1 is a perspective view of a wearer using an embodiment of the invention to repair an automobile.

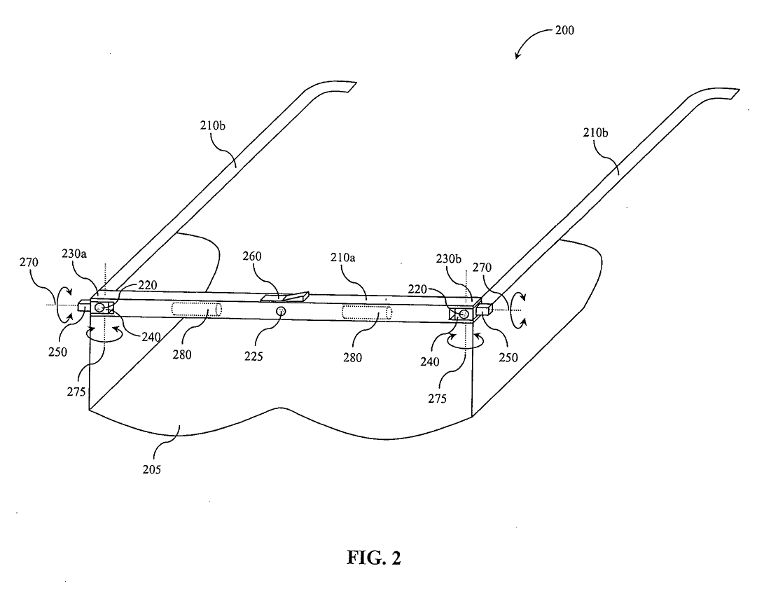

FIG. 2 is a perspective view of an embodiment of the invention with three lights.

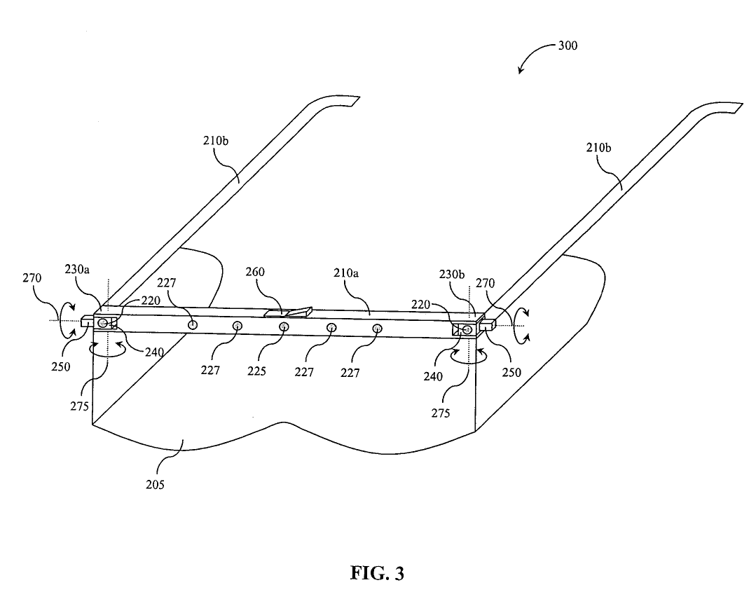

FIG. 3 is a perspective view of another embodiment of the invention with seven lights.

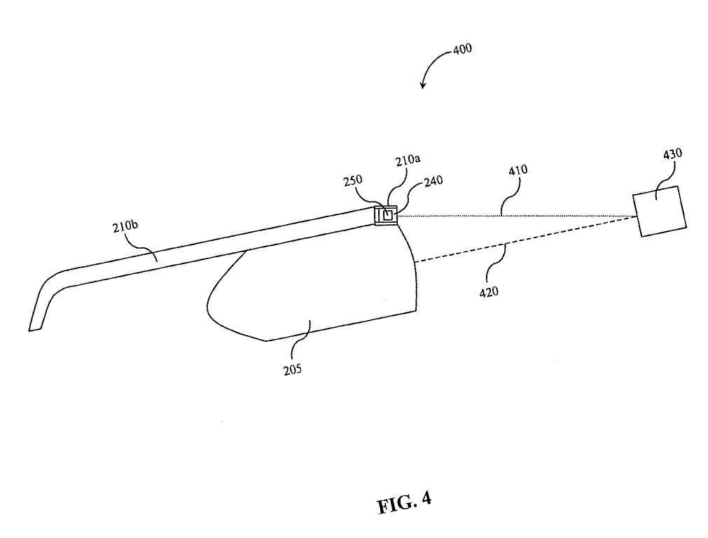

FIG. 4 is a side view of another embodiment of the invention with the lights positioned slightly downward.

### DETAILED DESCRIPTION

Generally, an illuminated eye protection device provides a wearer with safety and helps assist the wearer in performing a variety of tasks when there is insufficient illumination. For example, as shown in FIG. 1, a wearer 120, such as an automobile mechanic, can use the illuminated eye protection device 140 in a low light environment, such as moonlight 130, to illuminate an automobile engine compartment 160 such that the wearer 140 can safely and effectively repair an automobile 110. The illuminated eye protection device 140 provides a beam of light 150 that can be focused by the wearer 120 to a specific location to provide the wearer with a well lit view of the area to be illuminated.

In one embodiment, as shown in FIG. 2, the illuminated eye protection device 200 has a frame 210, a lens 205 attached to the frame, a center light 225, and two rotatable periphery lights 220. The frame 210 and the lens 205 can be made from a polycarbonate material that is well known in the art and is preferably compliant with American National Safety Institute Standards. The frame 210 includes a pair of temples 210b and a bridge member 210a connecting the temples 210b. The lens 205 can be one piece, as in an eye shield or multiple pieces as in eyeglasses. The lights 220, 225 are integrated with the frame such that the integrity of the illuminated eye protection device is not compromised. The periphery lights 220 are located at opposing corners 230a, 230b of the frame 210. The lights 220, 225 can be light emitting diodes (LEDs) or any other suitable light source known in the art. However, white light LEDs provide greater illumination with less power consumption than typical incandescent lamps.

The periphery lights 220 are housed in light sockets 240 that allow for rotation about the center of axes 270 and 275 to provide a narrow beam or a wide beam of light on the work area. The light socket 240 can fit into a ball and socket type joint of the frame 210. Rotating each periphery light 220 inward toward the center light 225 produces the narrow beam of light, while rotating each periphery light 220 outward away from the center light 225 produces the wide beam of light. However, in another embodiment the periphery lights 220 can be permanently fixed inward toward the center light 225 to provide a wearer with maximum illumination at arms length.

A knob 250 can separately rotate each periphery light 220. The knob is attached to the light socket 240 such that the wearer can rotate each periphery light 220 by moving the knob in a direction about the axes 270, 275. The knob can be a protrudable member that allows for rotation about the axes, such as a tab.

As shown in FIG. 2, a switch 260 is located above the center light 225 on top of the frame 210 and controls the lights 220, 225. However, it should be understood that in other embodiments the switch can be located anywhere on the frame. Further, in other embodiments, separate switches 260 located on the frame can control a respective light 220, 225. The switch 260 can be a rocker-type switch, a push button-type switch, a hinge-type switch, or a photovoltaic-type switch, or any other switch known in the art.

A power source 280 provides power to the lights 220, 225. The power source 280 is integrated within the frame 210. The power source 280 can be located on either side of the center light 225 above the lens 205 or two power sources 280 can be located one on each side of the center light 225 above the lens 205. The power source 280 can be a battery, solar cell, or any other power source known in the art. Each light 220, 225 can be powered by a single power source 280, multiple power sources 280, or a separate dedicated power source 280 for each light 220, 225.

In another embodiment, as shown in FIG. 3, the illuminated eye protection device 300 has a frame 210, a lens 205, a center light 225, two rotatable periphery lights 220, and four additional lights 227 located symmetrically about the center light 225 to provide greater illumination. Although seven lights are shown, the present approach encompasses embodiments having any number of lights.

In another embodiment, as shown in FIG. 4, the bridge member 210a housing the lights 220, 225 is positioned slightly downward from the temples 210b on the illuminated eye protection device 400 to provide a beam of light. The center of the beam of light 410 intersects with the wearer's line of sight 420, thus providing greater illumination of an object being viewed 430.

While this invention has been particularly shown and described with references to preferred embodiments thereof, it will be understood by those skilled in the art that various changes in form and details may be made therein without departing from the scope of the invention encompassed by the appended claims.

What is claimed is:

1. An illuminated eye protection device comprising:
a frame, the frame having a first corner and a second corner;
a lens member attached to the frame; and
at least three lights integrated with the frame above the lens member, wherein a first light of the at least three lights is rotatably mounted to the first corner of the frame, a second light of the at least three lights is rotatably mounted to the second corner of the frame, and a third light of the at least three lights is mounted to the center of the frame above the lens member.

2. The illuminated eye protection device according to claim 1, further comprising at least one power source integrated with the frame, the power source electrically coupled to the at least three lights.

3. The illuminated eye protection device according to claim 2, wherein the at least one power source is a battery or a solar cell.

4. The illuminated eye protection device according to claim 2, wherein a first power source is located aside the center light.

5. The illuminated eye protection device according to claim 4, further comprising a second power source located opposite the first power source and aside the center light.

6. The illuminated eye protection device according to claim 2, further comprising a switch integrated with the frame, the switch electrically coupled to the at least three lights and the at least one power source.

7. The illuminated eye protection device according to claim 6, wherein the switch is a rocker switch.

8. The illuminated eye protection device according to claim 1, further comprising a protruding member coupled to each of the first light and second light.

9. The illuminated eye protection device according to claim 8, wherein the protruding member controls the rotation of each of the first light and second light.

10. The illuminated eye protection device according to claim 1, wherein the at least three lights point downward.

11. The illuminated eye protection device according to claim 1, wherein the lights are light emitting diodes (LEDs).

12. The illuminated eye protection device according to claim 11, wherein the LEDs are white light LEDs.

13. The illuminated eye shields according to claim 1, wherein the lens member is made from a polycarbonate material.

14. The illuminated eye protection device according to claim 1, wherein the frame is made from a polycarbonate material.

15. The illuminated eye protection device according to claim 1, wherein the eye protection device is an illuminated safety shield or illuminated safety glasses.

16. The illuminated eye protection device according to claim 1, wherein the frame includes a pair of temples and a bridge member connecting the temples, the bridge member being positioned downward from the temples to provide a beam of light which intersects a wearer's line of sight.

17. A method of protecting a human eye, comprising:
wearing an eye protection device having plural lights;
activating the plural lights on the eye protection device; and
directing the lights to form a beam of light on a work area.

18. An illuminated eye protection device, comprising:
means for protecting a human eye;
means for illuminating a work area; and
means for rotating the means for illuminating to provide a concentrated beam of light on the work area.
